(19) United States
(12) Patent Application Publication
(10) Pub. No.: US 2009/0229995 A1
(43) Pub. Date: Sep. 17, 2009

(54) Analysis of fluoride at low concentrations in acidic processing solutions

(75) Inventors: Eugene Shalyt, Washington Township, NJ (US); Michael Pavlov, Fairlawn, NJ (US); Peter Bratin, Flushing, NY (US)

Correspondence Address: D. MORGAN TENCH, 1180 CORTE RIVIERA, CAMARILLO, CA, 93010, US

(73) Assignee: ECI Technology, Inc.

(21) Appl. No.: 12/075,868

(22) Filed: Mar. 14, 2008

(51) Int. Cl. G01N 27/26; G01N 27/416

(52) U.S. Cl. 205/778.5; 204/406; 204/405

(57) ABSTRACT

Low concentrations of fluoride ion in a semiconductor processing solution containing an acid are determined via fluoride ion specific electrode measurements corrected for the effect of the acid concentration. No reagents are used for the fluoride determination.

### BACKGROUND OF THE INVENTION

1. Field of the Invention

This invention is concerned with analysis of semiconductor processing solutions, particularly cleaning solutions containing low concentrations of fluoride ion.

2. Description of the Related Art

In the semiconductor industry, etching of semiconductor wafers is an important process, typically involving definition of fine circuitry features in a thin layer of silicon oxide (SiO₂) on the surface of a silicon wafer. The etching process is generally performed in an aqueous etchant solution (bath) containing a fluoride etchant. Because of the thin layers and fine circuitry features involved, the etch rate of the silicon oxide must be closely controlled to provide acceptable results with high yield. Furthermore, surface preparation and cleaning solutions generally employed as part of the etching process often contain low concentrations of fluoride, which produce mild etching of the silicon oxide that must also be controlled.

U.S. Patent Application Publication No. 2005/0028932 to Shekel et al. (published 10 Feb. 2005) describes a method based on near infrared (NIR) spectroscopy and chemometric data manipulation for determining the etch rate of semiconductor wafer materials in fluoride etching baths, as well as the concentrations of fluoride species in etching baths and semiconductor surface preparation and cleaning solutions. For some surface preparation and cleaning solutions, however, the fluoride concentration is below the detection limit for NIR spectroscopy. One cleaning solution used to remove polymer photoresist residues following the wafer etching process, for example, comprises 2 to 30 wt % sulfuric acid (H₂SO₄), 0 to 20 wt % hydrogen peroxide (H₂O₂), and 10 to 1000 ppm hydrogen fluoride (HF). For such diluted sulfuric/peroxide (DSP) solutions, the fluoride concentration must be closely controlled to avoid inadequate polymer residue removal at lower concentrations and excessive SiO₂ etching at higher concentrations.

A leading prior art method for determining the fluoride concentration in DSP solutions is embodied in a commercial instrument (HF-700 by Horiba) based on fluoride detection via a fluoride ion specific electrode (ISE). In this prior art method, an alkaline reagent solution is added to increase the pH of a sample of the DSP solution (to around pH 7) so as to provide practically complete ionization of HF to F⁻ ions, which are detected by the fluoride ISE. Since the concentration of F⁻ ions may be too small to be accurately measured by the fluoride ISE, especially after dilution of the sample by addition of an alkaline solution to adjust the pH, the F⁻ concentration in the sample is increased by standard addition of a fluoride reagent solution. A significant disadvantage of this prior art method is the use of reagent solutions, which generates an undesirable waste stream.

An objective of the present invention is to provide a method and an apparatus for measuring low concentrations of fluoride in semiconductor surface preparation and cleaning solutions without generating a waste stream. The prior art teaches that sulfuric acid interferes with detection of fluoride by an ion specific electrode so that reagents must be used. The inventors, however, have discovered that low concentrations of fluoride ion in an acidic solution can be accurately determined by correcting fluoride ISE measurements for the concentration of acid in the solution.

### SUMMARY OF THE INVENTION

The invention provides a method and an apparatus for determining the fluoride concentration in dilute processing solutions of the type used for surface preparation and cleaning of silicon wafers. Such solutions generally comprise hydrogen fluoride (HF) and a relatively strong acid (H₂SO₄, HNO₃, HCl or CH₃COOH, for example), and may also comprise an oxidizing agent (H₂O₂ or O₃, for example). The invention is especially suitable for fluoride analysis of diluted sulfuric/peroxide (DSP) baths used to remove photoresist polymer residues from the surfaces of etched wafers. A typical DSP bath comprises 10 to 1000 ppm hydrogen fluoride (HF), 2 to 15 wt % sulfuric acid (H₂SO₄), and 0 to 20 wt % hydrogen peroxide (H₂O₂).

In the method of the invention for determining the fluoride concentration in a processing solution containing an acid, the potential of a fluoride ion specific electrode (ISE) is measured in the processing solution, and the measured potential is corrected for the effect of the concentration of the acid in the processing solution to provide an accurate determination of the fluoride concentration. Within the scope of the invention, one or more optional corrections may also be applied to take into account substantial variations in the temperature of the processing solution, or in the concentrations of other processing solution constituents, an oxidizing agent such as peroxide, for example, so as to further improve the accuracy of the fluoride concentration determination. As those skilled in the art will appreciate, such corrections may be applied to the potential measured for the fluoride ISE, or to an uncorrected fluoride concentration corresponding to the potential measured for the fluoride ion specific electrode.

The basic steps of the method of the invention for determining the fluoride concentration in a processing solution containing an acid, comprise: placing a fluoride ion specific electrode (ISE) and a reference electrode in contact with the processing solution; measuring the potential of the fluoride ISE relative to the reference electrode; determining the concentration of the acid in the processing solution; and correcting for the effect of the concentration of the acid in the processing solution on the potential measured for the fluoride ISE to determine the fluoride concentration in the processing solution. In a preferred embodiment, the method further comprises the steps of: determining the concentration of an oxidizing agent in the processing solution; and correcting for the effect of the concentration of the oxidizing agent in the processing solution on the potential measured for the fluoride ISE in order to provide a more accurate determination of the fluoride concentration in the processing solution. In an embodiment preferred for applications involving processing solutions that operate at elevated temperatures, the method further comprises the steps of: measuring the temperature of the processing solution; and correcting for the effect of the measured temperature on the potential measured for the fluoride ISE in order to provide a more accurate determination of the fluoride concentration in the processing solution. For the various embodiments, the temperature of the processing solution and the concentrations of the acid and the oxidizing agent may be determined by any suitable means.

The apparatus of the invention, which enables automated application of the method of the invention for on-line process control, comprises: a fluoride ion specific electrode (ISE) in contact with the processing solution; a reference electrode in contact with the processing solution; a voltmeter for measuring the potential of the fluoride ISE relative to the reference electrode; a means of determining the concentration of the acid in the processing solution; and a computing device having a memory element with a stored algorithm operative to effect, via appropriate electronic and mechanical equipment and interfacing, at least the basic steps of the method of the invention. The apparatus of the invention may optionally comprise a means of determining the concentration of an oxidizing agent in the processing solution, and/or a means of measuring the temperature of the processing solution. In a preferred embodiment, the apparatus of the invention comprises an NIR spectrometer, and the acid concentration, and optionally the oxidizing agent concentration and the temperature of the processing solution, are determined by NIR spectroscopy.

The apparatus of the invention may further comprise: an analysis cell; and a sampling device for flowing a sample of the processing solution into the analysis cell. In a preferred embodiment, a first sample of the processing solution is flowed via an ISE sampling device into an ISE analysis cell, and a second sample of the processing solution is flowed via an NIR sampling device into an NIR analysis cell. In this case, the computing device with the stored algorithm is preferably further operative to control the sampling devices.

The apparatus of the invention may further comprise or be used in conjunction with an automated chemical delivery system. In this case, the computing device is further operative to control the chemical delivery system so as to automatically replenish fluoride, and optionally one or more other constituents of the processing solution, based on the fluoride concentration and the optional concentrations of other processing solution constituents determined via the method and apparatus of the invention.

The invention is useful for reducing the costs and environmental impact of providing needed process controls for surface preparation and cleaning solutions used in processing silicon wafers. A key feature of the invention is that the fluoride concentration in such processing solutions may be determined in some embodiments without using any reagents so that no waste stream is generated and automation of the bath analysis system is greatly simplified. In particular, rinsing of the analysis cell between analyses in order to avoid cross-contamination errors is unnecessary for such embodiments. In other embodiments of the invention, the number of reagents required is reduced. The invention is also useful for improving the quality and yield of semiconductor wafers by providing a method and an apparatus for controlling fluoride ion at low concentrations in acidic cleaning baths so as to provide effective cleaning while avoiding excessive silicon oxide etching.

Further features and advantages of the invention will be apparent to those skilled in the art from the following detailed description, taken together with the accompanying drawings.

### BRIEF DESCRIPTION OF THE DRAWINGS

FIG. 1 shows plots of the potential of a fluoride ISE versus the fluoride concentration for standard solutions containing various concentrations of sulfuric acid.

FIG. 1 shows representative plots of the potential of a fluoride ISE versus the log of the fluoride concentration for standard solutions containing 4.11 wt % hydrogen peroxide and various concentrations of sulfuric acid.

FIG. 2 shows representative plots of the potential of a fluoride ISE versus the log of the concentration of sulfuric acid for standard solutions containing 4.11 wt % hydrogen peroxide and various concentrations of fluoride.

### DETAILED DESCRIPTION OF THE INVENTION

Technical terms used in this document are generally known to those skilled in the art. The term “standard addition” generally means addition of a predetermined quantity of a species to a predetermined volume of a solution (a sample of a processing solution, for example). The predetermined quantity may be a predetermined weight of the species or a predetermined volume of a standard solution containing the species. A “standard solution” comprises a precisely known concentration of a reagent used for a chemical analysis. The symbol “M” means molar concentration. Calibration data are typically handled as calibration curves or plots but such data may be tabulated and used directly, especially by a computer, and the terms “curve” or “plot” include tabulated data.

Unless indicated otherwise, the terms “cleaning solution”, “cleaning bath” and 'bath” generally refer to solutions having the same composition but the word “bath” denotes the solution in a tank or reservoir in a production process. Likewise, a “processing solution” and a “processing bath” have the same composition but the processing bath is contained in a tank or reservoir in a production process. The generic term “peroxide” encompasses peroxide compounds, hydrogen peroxide (H₂O₂), for example, and peroxide ions, HO₂⁻ and O₂²⁻, for example.

The invention may be used to determine the fluoride concentration in any suitable semiconductor processing solution. The terms “fluoride” and “fluoride concentration” encompass all fluoride species, including HF and fluoride ion. Thus, the invention provides the total fluoride concentration in the processing solution. The invention is particularly useful for analysis and control of semiconductor surface preparation and cleaning solutions. In addition to fluoride, such solutions generally comprise a relatively strong acid, such as sulfuric acid (H₂SO₄), nitric acid (HNO₃), hydrochloric acid (HCl), acetic acid (CH₃COOH), and combinations thereof. Such solutions may also comprise an oxidizing agent, peroxide or ozone (O₃), for example. Note that oxygen from the atmosphere is generally present and may function in some systems as a mild oxidizing agent, especially when a more reactive oxidizing agent is not present.

The salient features of the invention may be illustrated by considering the diluted sulfuric/peroxide (DSP) solution widely used to remove photoresist polymer residues from the surfaces of etched wafers. The DSP solution typically comprises 10 to 1000 ppm hydrogen peroxide (HF), 2 to 30 wt % sulfuric acid (H₂SO₄), and 0 to 20 wt % hydrogen peroxide (H₂O₂). In the aqueous DSP solution, HF dissociates according to:

HF=H⁺+F⁻ (1)

providing the fluoride ions that are detected by the fluoride ion specific electrode. Under ideal conditions, the potential (E) of a fluoride ISE is given by the well-known Nernst equation:

E=Eₒ−(2.303 RT/nF)log [F⁻] (2)

where Eₒ is the standard equilibrium potential, R is the natural gas constant, T is the temperature (°K), n is the number of electrons transferred in the electrode reaction, F is faradays constant, and [F⁻] is the activity of fluoride ion. The value of 2.303 RT/nF is 59 mV/decade for a one-electron reaction at 25° C. Thus, were HF completely dissociated into H⁺ and F⁻ ion, a plot of the potential of a fluoride ISE versus log [F⁻] should be linear with a slope of 59 mV/decade.

In order to accurately determine the total fluoride concentration (HF+F⁻ ion), undissociated HF, which is not detected by the fluoride ISE, must be taken into account. The fluoride ion activity [F⁻] with respect to the equilibrium of equation (1) may be expressed as;

[F⁻]=K[HF]/[H⁺] (3)

where K is the equilibrium constant and [HF] and [H⁺] are activities. Increased H⁺ concentration increases the concentration of HF, and decreases the concentration of F⁻ ion detected by the fluoride ISE. The concentration of H⁺ is determined predominantly by dissociation of sulfuric acid:

H₂SO₄=2 H⁺+SO₄²⁻ (4)

which, compared to HF, is a much stronger acid and is present at much higher concentration. When the concentration of H⁺ derived from HF is negligible and H₂SO₄ is completely dissociated, [H⁺]=2×[H₂SO₄] so that [F-] is proportional to the [HF]/[H₂SO₄] ratio. In this case, the Nernst equation for the potential (E) of the fluoride ISE may be written as:

E=(59 mV)log [H₂SO₄]−(59 mV)log [HF]+Constant (5)

at 25° C. When the acid concentration is constant, [F⁻] is directly proportional to [HF] so that a plot of fluoride ISE potential versus log [H] provides a linear calibration curve (with a slope of 59 mV/decade) for determining the fluoride concentration in an unknown solution. Equation (5) also indicates that a correction of 59 mV/decade of log [H₂SO₄] is needed to correct for deviations in the acid concentration.

In practice, the Nernstian slopes for both fluoride and sulfuric deviate from the theoretical values (59 mV/decade) due to non-ideal solution behavior (non-unity activity coefficients), incomplete H₂SO₄ dissolution, and/or non-negligible H⁺ contribution from HF dissociation. In addition, electrodes may exhibit electrode-to-electrode variations and potential drift with time. Slopes measured using a combination fluoride ion specific electrode/silver-silver chloride reference electrode (4.0 M KCl) were about 57 mV/decade for fluoride calibration solutions (containing 0.005 to 0.015 wt % HF), and about 50 mV/decade for acid calibration solutions (containing 1 to 20 wt % H₂SO₄).

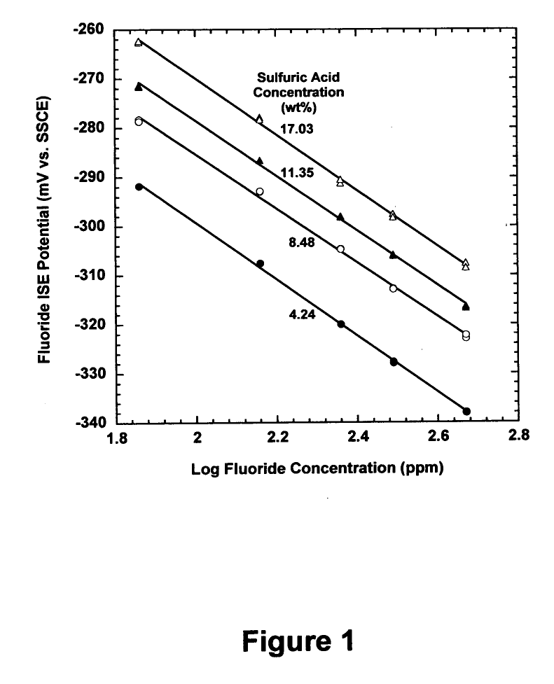

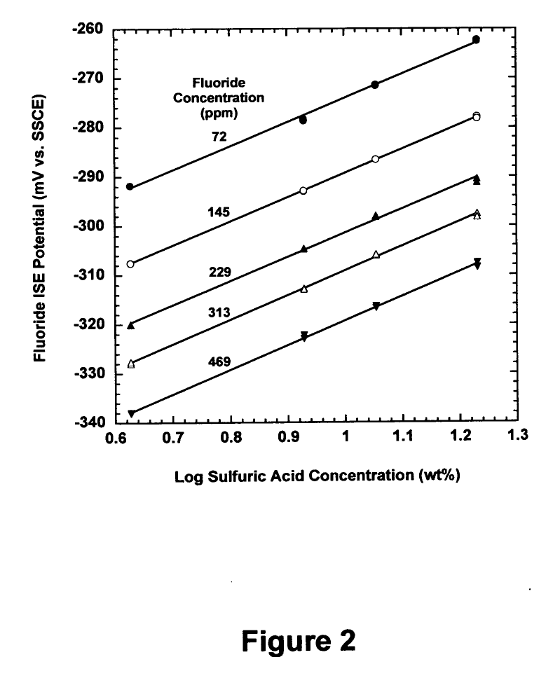

FIG. 1 shows representative plots of the potential of a fluoride ISE versus the log of the fluoride concentration for standard solutions containing 4.11 wt % hydrogen peroxide and various concentrations of sulfuric acid. As expected from the Nernst expression, the fluoride ISE potential decreases linearly with log fluoride concentration and is shifted positively for higher acid concentrations. The Nernstian slope in this case ranged from 55 to 57 mV/decade (average 56 mV/decade).

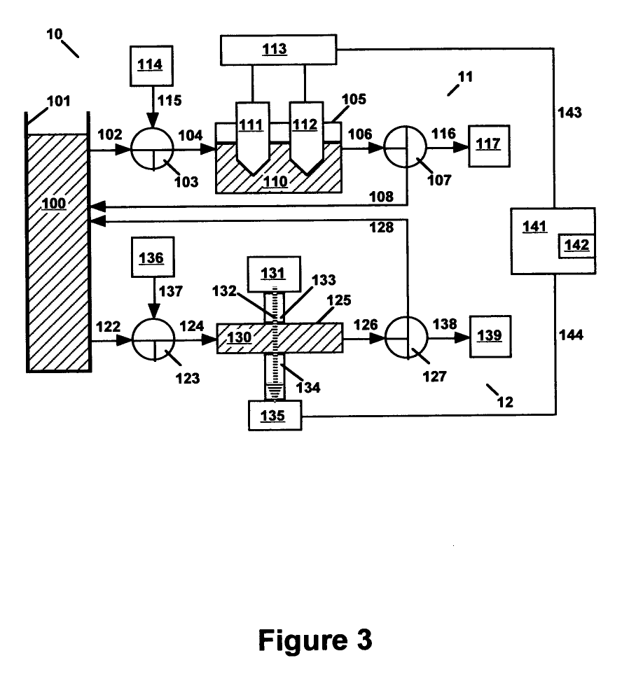

FIG. 2 shows representative plots of the potential of a fluoride ISE versus the log of the concentration of sulfuric acid for standard solutions containing 4.11 wt % hydrogen peroxide and various concentrations of fluoride. As expected from the Nernst expression, the fluoride ISE potential increases linearly with log acid concentration and is shifted negatively for higher fluoride concentrations. The Nernstian slope in this case ranged from 48 to 50 mV/decade (average 49 mV/decade). Such data are used, according to the invention, to correct the potential of a fluoride ISE for variations in the concentration of sulfuric acid in DSP solutions so as to provide an accurate determination of the fluoride concentration.

The method of the invention for determining the fluoride concentration in a processing solution comprising an acid, comprises the basic steps of: placing a fluoride ion specific electrode (ISE) and a reference electrode in contact with the processing solution; measuring the potential of the fluoride ISE relative to the reference electrode; determining the concentration of the acid in the processing solution; and correcting for the effect of the concentration of the acid in the processing solution on the potential measured for the fluoride ISE to determine the fluoride concentration in the processing solution.

The concentration of the acid in the processing solution may be determined by any suitable method, including one selected from the group consisting of near infrared (NIR) spectroscopy, pH electrode measurements, and acid-base titration. Suitable procedures and equipment for performing analyses using any of these methods are known in the art. Near infrared spectroscopy and pH electrode measurements have the advantage of not generating a waste stream.

In an alternative embodiment, the reference electrode comprises a pH electrode. In this case, the reference electrode potential changes with the acid concentration (pH) of the solution so as to automatically compensate for the effect of the acid concentration on the potential of the fluoride ion specific electrode, according to the Nernst expression (equation 5). In principle, the potential of fluoride ISE relative to the pH electrode provides a measure of the fluoride concentration regardless of the acid concentration. To provide highest accuracy for the fluoride determination, however, the fluoride ISE is preferably calibrated using standard fluoride solutions to correct for non-ideal solution behavior (non-unity activity coefficients), incomplete H₂SO₄ dissolution, and/or non-negligible H⁺ contribution from HF dissociation, and to take into account potential drift for one or both of the electrodes.

The method of the invention may further comprise the steps of: determining the concentration of an oxidizing agent in the processing solution; and correcting for the effect of the concentration of the oxidizing agent in the processing solution on the potential measured for the fluoride ISE in order to provide a more accurate determination of the fluoride concentration in the processing solution. The concentration of the oxidizing agent in the processing solution may be determined by any suitable means. The concentration of peroxide, which is widely used in semiconductor processing solutions, may be determined by NIR spectroscopy, or by titration with a cerium sulfate titrant in the presence of sulfuric acid using a platinum indicator electrode, for example. In some cases, the concentration of the oxidizing agent may be sufficiently controlled in the processing solution that its effect on the fluoride determination of the invention may be neglected.

The method of the invention may further comprise the steps of: measuring the temperature of the processing solution; and correcting for the effect of the measured temperature on the potential measured for the fluoride ISE in order to provide a more accurate determination of the fluoride concentration in the processing solution. The temperature of the processing solution may be measured by any suitable means including one selected from the group consisting of NIR spectroscopy, thermocouple measurement, and thermistor measurement. A temperature increase may be detected via NIR spectroscopy, for example, from a broadening of the water absorption peak, or a shift in this peak to longer wavelengths. Correction for the effect of temperature on the potential of the fluoride ISE may be made via the Nernst expression (equation 2), or empirically based on a temperature calibration curve.

A preferred analysis method for use in conjunction with the fluoride ISE determination of the invention is near infrared (NIR) spectroscopy, which may be used to determine the acid concentration, and optionally an oxidizing agent concentration and/or the temperature of the processing solution. In addition, NIR measurements typically do not involve added reagents so that no waste stream is generated by the NIR analysis.

Calibration to provide a database for NIR analysis of the processing solution involves correlating the concentration of the acid, and optionally the concentration of the oxidizing agent, for standard solutions with the magnitude of an NIR spectral feature. Generally, NIR calibration is performed initially and re-calibration is performed only infrequently so that little waste is generated. Typically, re-calibration involves a standard solution having the target processing solution composition, which may be returned to the processing solution tank so that no waste is generated.

Spectroscopic methods and equipment for analysis of species in solution are well-known in the art. Near infrared spectroscopy typically involves radiation absorption measurements in the 700 to 2500 nm wavelength range, which is especially suitable for analysis of species in aqueous solutions. Absorption measurements are typically performed as a function of radiation wavelength to generate an absorption spectrum. The magnitude of a spectral feature, typically a peak or a shoulder, corresponding to absorption of radiation by a specific species is used to determine the concentration of the species. NIR measurements are typically performed over a relatively wide wavelength range but may be performed at a single wavelength or over a narrow wavelength range for analysis of a specific species. In some embodiments of the invention, it may be advantageous to perform chemometric manipulation of NIR spectra to determine the acid concentration, and optionally an oxidizing agent concentration and/or the temperature of the processing solution. Application of NIR spectroscopy and chemometric data manipulation to analysis of semiconductor processing solutions is described in U.S. Patent Application Publication No. 2005/0028932 to Shekel et al. (published 10 Feb. 2005), which is hereby incorporated by reference.

In a preferred embodiment, the method of the invention further comprises the step of: calibrating the fluoride ISE by periodically placing the fluoride ISE and the reference electrode in contact with an ISE calibration solution containing a predetermined concentration of fluoride, and measuring the potential of the fluoride ISE relative to the reference electrode. This calibration procedure determines any offset voltage needed to correct for drift in the potential of the fluoride ion specific electrode. Calibration of the fluoride ISE is typically performed infrequently, daily, for example, so that only a small amount of waste is generated. In some cases, the ISE calibration solution may be added to the processing solution so that no waste is generated.

The apparatus of the invention for determining the fluoride concentration in a processing solution containing an acid, comprises: a fluoride ion specific electrode (ISE) in contact with the processing solution; a reference electrode in contact with the processing solution; a voltmeter for measuring the potential of the fluoride ISE relative to the reference electrode; a means of determining the concentration of the acid in the processing solution; and a computing device having a memory element with a stored algorithm operative to effect, via appropriate interfacing, at least the basic steps of the method of the invention, comprising, measuring the potential of the fluoride ISE relative to the reference electrode, determining the concentration of the acid in the processing solution, and correcting for the effect of the concentration of the acid in the processing solution on the potential measured for the fluoride ISE to determine the fluoride concentration in the processing solution. The concentration of the acid in the processing solution may be determined by any suitable means, including use of a near infrared (NIR) spectrometer, a pH electrode, or a titration analyzer, for example. The voltage of a pH electrode may be measured using the same voltmeter used to measure the potential of the fluoride ISE relative to the reference electrode, or a different voltmeter.

Suitable reference electrodes and fluoride ion specific electrodes are available commercially. Typical reference electrodes include the silver-silver chloride electrode (SSCE), saturated calomel electrode (SCE), mercury-mercury sulfate electrode, for example. A double-junction may be used for one or both electrodes to minimize contamination of the processing solution by electrode species, or of the electrode solution by processing solution species (which may cause drift in the electrode potential). The fluoride ISE and the reference electrode may be separate electrodes or may be combined in a combination electrode.

The apparatus of the invention may further comprise: a means of determining the concentration of an oxidizing agent in the processing solution. In this case, the computing device is preferably further operative to effect the additional steps of the method of the invention, comprising, determining the concentration of the oxidizing agent in the processing solution, and correcting for the effect of the concentration of the oxidizing agent in the processing solution on the potential measured for the fluoride ISE in order to provide a more accurate determination of the fluoride concentration in the processing solution. Any suitable means may be used to determine the concentration of the oxidizing agent in the processing solution. In a preferred embodiment, the oxidizing agent concentration is determined using an NIR spectrometer. The concentration of some oxidizing agents may be determined using a titration analyzer.

The apparatus of the invention may further comprise: a means of measuring the temperature of the processing solution. In this case, the computing device is preferably further operative to effect the additional steps of the method of the invention, comprising, measuring the temperature of the processing solution, and correcting for the effect of the measured temperature on the potential measured for the fluoride ISE in order to provide a more accurate determination of the fluoride concentration in the processing solution. The temperature may be measured by any suitable means, including use of an NIR spectrometer, a thermocouple, or a thermistor, for example.

Fluoride ISE measurements according to the invention may be performed with the fluoride ISE and reference electrode in direct contact with the processing solution. In this case, however, contamination of the processing solution due to leakage or failure of one or both of the electrodes may be a consideration. In addition, the environment of the processing solution tank may not be conducive to sensitive potential measurements and/or maintenance and calibration of the electrodes.

In a preferred embodiment, the apparatus of the invention further comprises: an ISE analysis cell; and an ISE sampling device operative to flow a sample of the processing solution into the ISE analysis cell and in contact with the fluoride ISE and the reference electrode. In this case, the computing device with the stored algorithm is preferably further operative to control the ISE sampling device.

In another preferred embodiment, the concentration of the acid in the processing solution, and optionally the concentration of an oxidizing agent and/or the temperature of the processing solution, is determined by NIR spectroscopy and the apparatus of the invention further comprises: an NIR analysis cell; and an NIR sampling device for flowing a sample of the processing solution into the NIR analysis cell. In this case, the computing device with the stored algorithm is preferably further operative to control the NIR sampling device.

In another preferred embodiment, the apparatus of the invention further comprises: a chemical delivery system. In this case, the computing device with the stored algorithm is preferably further operative to control the chemical delivery system so as to automatically replenish fluoride, and optionally one or more other constituents of the processing solution, based on the fluoride concentration and the optional concentrations of other processing solution constituents determined via the method and apparatus of the invention.

### Description of a Preferred Embodiment

The efficacy of the invention for determining the concentration of fluoride ion in a processing solution was demonstrated for DSP standard solutions for which the H₂SO₄ concentration was varied from 1 to 15 wt %, the H₂O₂ concentration was varied from 1 to 10 wt %, and the HF concentration was varied from 0.005 to 0.015 wt %. Measurements were made at room temperature using a combination fluoride ion specific electrode/silver-silver chloride reference electrode (4.0 M KCl).

Table 1 summarizes the results for a series of fluoride determinations for DSP solutions according to the invention. Errors were generally less than 3 percent.

TABLE 1
Fluoride Determinations for DSP Processing Solutions

| | | |
|---|---|---|
| Solution | | |
| Composition | Fluoride ISE | Calculated |

| Fluoride | Acid | Voltage | Fluoride | Error |
|---|---|---|---|---|
| (ppm) | (wt %) | (mV vs. SSCE) | (ppm) | (%) |
| 50 | 5 | −273 | 50 | 0 |
| 100 | 5 | −289 | 99 | 1 |
| 150 | 5 | −298 | 150 | 0 |
| 50 | 15 | −259 | 51 | 2 |
| 100 | 15 | −273 | 97 | 3 |
| 150 | 15 | −283 | 155 | 3 |
| 50 | 25 | −254 | 50 | 0 |
| 100 | 25 | −269 | 98 | 2 |
| 150 | 25 | −278 | 151 | 1 |

FIG. 1 depicts a preferred apparatus of the invention, which comprises an ISE analysis system 11 and an NIR analysis system 12. ISE analysis system 11 comprises a fluoride ion specific electrode 111 and a reference electrode 112 in contact with a sample 110 of a processing solution 100 contained in an ISE analysis cell 105. For the fluoride ISE analysis, a computing device 141 measures the potential of fluoride ion specific electrode 111 relative to reference electrode 112 via a voltmeter 113 and an electrical cable 143.

Preferred ISE analysis system 11 further comprises an ISE sampling system comprising selector valves 103 and 107. The arrows indicate the direction of solution flow. For ISE measurements, selector valves 103 and 107 may be switched as indicated so that sample 110 of processing solution 100 flows, continuously or intermittently, from a processing tank 101 (via tubes 102 and 104) into ISE analysis cell 105, and back to processing tank 101 (via tubes 106 and 108). In this case, no waste stream is generated. When contamination of processing solution 100 by species leaking from fluoride ion specific electrode 111 or reference electrode 112 is a consideration, selector valve 107 may be switched for ISE measurements such that ISE sample 110 flows to an ISE waste reservoir 117 (via tubes 106 and 116).

For calibration of fluoride ion specific electrode 111, selector valves 103 and 107 are switched such that an ISE calibration solution containing a known concentration of fluoride flows from an ISE calibration reservoir 114 into ISE analysis cell 105 (via tubes 115 and 104) and into ISE waste reservoir 117 (via tubes 106 and 116). In this case, the potential of fluoride ISE electrode 111 is measured relative to reference electrode 112 to determine any offset voltage needed to correct for drift in the potential of fluoride ion specific electrode 111. Calibration of fluoride ion specific electrode 111 is typically performed infrequently so that only a small amount of waste is generated. In some cases, the ISE calibration solution may be returned to processing solution tank 101 so that no waste is generated.

NIR analysis system 12 of FIG. 1 comprises: a near infrared (NIR) radiation source 131 operative to provide a measurement beam 132 of NIR radiation; a fiber optic system comprising fiber optic elements 133 and 134 operative to pass measurement beam 132 through a sample 130 of processing solution 100 contained in an NIR analysis cell 125; and a detector 135 operative to measure the intensity of measurement beam 132 passed through sample 130 as a function of the NIR radiation wavelength over a predetermined spectral region so as to generate an NIR spectrum of processing solution 100.

NIR analysis cell 125 may be of any suitable configuration. Preferably, NIR analysis cell 125 comprises an NIR-transparent tube of an NIR transparent material, Teflon, for example, through which processing solution 100 is flowed, continuously or intermittently. In this case, NIR analysis cell 125 includes a clamp for holding fiber optic elements 133 and 134 in mutual axial alignment and perpendicular to the axis of the NIR-transparent tube.

Preferred NIR analysis system 12 of FIG. 1 further comprises an NIR sampling system comprising selector valves 123 and 127. For NIR spectroscopy measurements, selector valves 123 and 127 are switched as indicated so that a sample 130 of processing solution 100 flows, continuously or intermittently, from a processing tank 101 (via tubes 122 and 124) into NIR analysis cell 125, and back to processing tank 101 (via tubes 126 and 128). In this case, no contamination of processing solution 100 occurs and no waste stream is generated.

For NIR calibration, selector valves 123 and 127 are typically switched such that an NIR calibration solution containing a known concentration of the acid, and optionally an oxidizing agent, flows from an NIR calibration reservoir 136 into NIR analysis cell 125 (via tubes 137 and 124) and into a waste reservoir 139 (via tubes 126 and 138). In this case, the concentration of the acid, and optionally the concentration of the oxidizing agent, is correlated with the magnitude of an NIR spectral feature to provide the basis for NIR analysis of processing solution 100. Typically, NIR calibration is performed initially and re-calibration is performed only infrequently so that only a small amount of waste is generated. A typical NIR re-calibration solution has the same composition as the target processing solution and may be returned to processing solution tank 101 so that no waste is generated.

Preferred apparatus 10 of FIG. 1 further comprises: a computing device 141 having a memory element 142 with a stored algorithm operative to effect, via appropriate interfacing, at least the basic steps of the method of the invention. Computing device 141 preferably controls ISE analysis system 11 (via control cable 143), NIR analysis system 12 (via control cable 144), as well as both sampling systems, including selector valves 103, 107, 123 and 127, and the means of flowing processing solution 100.

Solution flow for the ISE and NIR sampling systems of FIG. 1 may be provided by any suitable means, including an impellor pump, a peristaltic pump, a syringe, or a metering pump, for example. Solution flow for the ISE and NIR sampling systems may be at the same rate or different rates, and may be adjusted via appropriate metering valves. The ISE and NIR sampling systems may also be configured so that processing solution 100 flows serially through NIR analysis cell 125 and ISE analysis cell 105, preferably in that order.

Computing device 141 may comprise a computer with integrated components, or may comprise separate components, a microprocessor and a memory device that includes memory element 142, for example. Memory element 142 may be any one or a combination of available memory elements, including a computer hard drive, a microprocessor chip, a read-only memory (ROM) chip, a programmable read-only memory (PROM) chip, a magnetic storage device, a computer disk (CD) and a digital video disk (DVD), for example. Memory element 142 may be an integral part of computing device 141 or may be a separate device. This preferred apparatus, and modifications thereof, may be used to practice various embodiments of the invention.

The preferred embodiments of the present invention have been illustrated and described above. Modifications and additional embodiments, however, will undoubtedly be apparent to those skilled in the art. Furthermore, equivalent elements may be substituted for those illustrated and described herein, parts or connections might be reversed or otherwise interchanged, and certain features of the invention may be utilized independently of other features. Consequently, the exemplary embodiments should be considered illustrative, rather than inclusive, while the appended claims are more indicative of the full scope of the invention.

We claim:

1. A method for determining the fluoride concentration in a processing solution comprising an acid, comprising the steps of:
placing a fluoride ion specific electrode (ISE) and a reference electrode in contact with the processing solution;
measuring the potential of the fluoride ISE relative to the reference electrode;
determining the concentration of the acid in the processing solution; and
correcting for the effect of the concentration of the acid in the processing solution on the potential measured for the fluoride ISE to determine the fluoride concentration in the processing solution.

2. The method of claim 1, wherein the acid is selected from the group consisting of sulfuric acid (H₂SO₄), nitric acid (HNO₃), hydrochloric acid (HCl), acetic acid (CH₃COOH), and combinations thereof, and the concentration of the acid in the processing solution is determined by a method selected from the group consisting of near infrared (MIR) spectroscopy, pH electrode measurements, and acid-base titration.

3. The method of claim 1, wherein the reference electrode comprises a pH electrode.

4. The method of claim 1, further comprising the steps of:
determining the concentration of an oxidizing agent in the processing solution; and
correcting for the effect of the concentration of the oxidizing agent in the processing solution on the potential measured for the fluoride ISE in order to provide a more accurate determination of the fluoride concentration in the processing solution.

5. The method of claim 4, wherein the oxidizing agent is selected from the group consisting of peroxide and ozone, and the concentration of the oxidizing agent in the processing solution is determined by a method selected from the group consisting of near infrared (NIR) spectroscopy and cerium sulfate titration.

6. The method of claim 1, further comprising the steps of:
measuring the temperature of the processing solution; and
correcting for the effect of the measured temperature on the potential measured for the fluoride ISE in order to provide a more accurate determination of the fluoride concentration in the processing solution, wherein the temperature of the processing solution is measured by a method selected from the group consisting of NIR spectroscopy, thermocouple measurement, and thermistor measurement.

7. The method of claim 1, wherein the processing solution comprises 10 to 1000 ppm hydrogen fluoride (HF), 2 to 30 wt % sulfuric acid (H₂SO₄), and 0 to 20 wt % hydrogen peroxide.

8. The method of claim 1, further comprising the step of:
calibrating the fluoride ISE by periodically placing the fluoride ISE and the reference electrode in contact with a calibration solution containing a predetermined concentration of fluoride, and measuring the potential of the fluoride ISE relative to the reference electrode.

9. An apparatus for determining the fluoride concentration in a processing solution containing an acid, comprising:
a fluoride ion specific electrode (ISE) in contact with the processing solution;
a reference electrode in contact with the processing solution;
a voltmeter for measuring the potential of the fluoride ISE relative to the reference electrode;
a means of determining the concentration of the acid in the processing solution; and
a computing device having a memory element with a stored algorithm operative to effect, via appropriate interfacing, at least the basic steps of the method of the invention, comprising
measuring the potential of the fluoride ISE relative to the reference electrode,
determining the concentration of the acid in the processing solution, and
correcting for the effect of the concentration of the acid in the processing solution on the potential measured for the fluoride ISE to determine the fluoride concentration in the processing solution,
wherein the fluoride ISE and the reference electrode may be separate electrodes or may be combined in a combination electrode.

10. The apparatus of claim 9, wherein the means of determining the concentration of the acid in the processing solution comprises a device selected from the group consisting of a near infrared (NIR) spectrometer, a pH electrode, and a titration analyzer.

11. The apparatus of claim 9, further comprising:
a means of determining the concentration of an oxidizing agent in the processing solution,
wherein the computing device is further operative to effect the additional steps of the method of the invention, comprising
determining the concentration of the oxidizing agent in the processing solution, and
correcting for the effect of the concentration of the oxidizing agent in the processing solution on the potential measured for the fluoride ISE in order to provide a more accurate determination of the fluoride concentration in the processing solution.

12. The apparatus of claim 9, further comprising:
a means of measuring the temperature of the processing solution,
wherein the computing device is further operative to effect the additional steps of the method of the invention, comprising
measuring the temperature of the processing solution, and
correcting for the effect of the measured temperature on the potential measured for the fluoride ISE in order to provide a more accurate determination of the fluoride concentration in the processing solution,
wherein the means for measuring the temperature comprises a device selected from group consisting of an NIR spectrometer, a thermocouple, and a thermistor.

13. The apparatus of claim 9, wherein the memory element is selected from the group consisting of computer hard drive, microprocessor chip, read-only memory (ROM) chip, programmable read-only memory (PROM) chip, magnetic storage device, computer disk (CD) and digital video disk (DVD).

14. The apparatus of claim 9, further comprising:
an ISE analysis cell; and
an ISE sampling device operative to flow a sample of the processing solution into the ISE analysis cell and in contact with the fluoride ISE and the reference electrode,
wherein said computing device with the stored algorithm is further operative to control the ISE sampling device.

15. The apparatus of claim 9, further comprising:
an NIR analysis cell; and
an NIR sampling device for flowing a sample of the processing solution into the NIR analysis cell,
wherein said computing device with the stored algorithm is further operative to control the NIR sampling device.

16. The apparatus of claim 9, further comprising:
a chemical delivery system,
wherein the computing device with the stored algorithm is further operative to control the chemical delivery system so as to automatically replenish fluoride, and optionally one or more other constituents of the processing solution, based on the fluoride concentration and the optional concentrations of other processing solution constituents determined via the method and apparatus of the invention.

17. An apparatus for determining the fluoride concentration in a processing solution containing an acid, comprising:
a fluoride ISE measurement system, comprising
an ISE analysis cell containing a first sample of the processing solution,
a fluoride ion specific electrode (ISE) in contact with the first sample of the processing solution,
a reference electrode in contact with the first sample of the processing solution, and
a voltmeter for measuring the potential of the fluoride ISE relative to the reference electrode;
an NIR spectroscopy measurement system, comprising
a near infrared (NIR) radiation source operative to provide a measurement beam of NIR radiation,
a fiber optic system operative to pass the measurement beam through a second sample of the processing solution contained in an NIR analysis cell,
a detector operative to measure the intensity of the measurement beam passed through the second sample of the processing solution as a function of the NIR radiation wavelength over a predetermined spectral region so as to generate an NIR spectrum of the processing solution; and
a computing device having a memory element with a stored algorithm operative to effect, via appropriate interfacing, the steps of the method of the invention, comprising
measuring the potential of the fluoride ISE relative to the reference electrode,
determining the concentration of the acid in the processing solution via NIR spectroscopy, and
correcting for the effect of the concentration of the acid in the processing solution on the potential measured for the fluoride ISE to determine the fluoride concentration in the processing solution,
wherein the fluoride ion specific electrode and the reference electrode may be separate electrodes or may be combined in a combination electrode.

18. The apparatus of claim 17, wherein the NIR radiation source is further operative to provide a reference beam of the NIR radiation and the intensity of the measurement beam is corrected for fluctuations in the intensity of the NIR radiation provided by the NIR radiation source based on the intensity of the reference beam.

19. The apparatus of claim 17, wherein the computing device is further operative to effect the additional steps of the method of the invention, comprising
determining the concentration of an oxidizing agent in the processing solution via NIR spectroscopy, and
correcting for the effect of the concentration of the oxidizing agent in the processing solution on the potential measured for the fluoride ISE in order to provide a more accurate determination of the fluoride concentration in the processing solution.

20. The apparatus of claim 17, wherein the computing device is further operative to effect the additional steps of the method of the invention, comprising
measuring the temperature of the processing solution via NIR spectroscopy, and
correcting for the effect of the measured temperature on the potential measured for the fluoride ISE in order to provide a more accurate determination of the fluoride concentration in the processing solution.

21. The apparatus of claim 17, further comprising:
a sampling system operative to flow the first and second samples of the processing solution into the ISE and NIR analysis cells, respectively,
wherein the first and second samples may be the same sample or different samples of the processing solution.
